(19) United States
(12) Patent Application Publication
(10) Pub. No.: US 2016/0139996 A1
(43) Pub. Date: May 19, 2016

(54) METHODS FOR PROVIDING UNIFIED STORAGE FOR BACKUP AND DISASTER RECOVERY AND DEVICES THEREOF

(71) Applicant: NetApp, Inc., Sunnyvale, CA (US)

(72) Inventors: Jose Mathew, Santa Clara, CA (US); Uday Joshi, Sunnyvale, CA (US); Atul Pandit, San Jose, CA (US)

(21) Appl. No.: 14/540,280

(22) Filed: Nov. 13, 2014

(51) Int. Cl. G06F 11/14; G06F 17/30

(52) U.S. Cl. CPC G06F 11/1451; G06F 17/30088; G06F 17/30194; G06F 11/1464; G06F 11/1469; G06F 2201/84

(57) ABSTRACT

A method, non-transitory computer readable medium, and device that providing a unified storage for backup and disaster recovery includes capturing a recent snapshot of one or more file systems associated with a client computing device. The captured recent snapshot is stored in a secondary storage device. One or more changes to one or more files in the one or more file systems are determined by comparing the stored recent snapshot against an initial snapshot. A response to a disaster recovery request or a backup request based on the determined one or more changes to the one or more file systems is provided.

### FIELD

This technology generally relates to storage management and, more particularly, methods for providing unified storage for backup and disaster recovery and devices thereof.

### BACKGROUND

A storage server is a special-purpose processing system used to manage file systems on behalf of client computing devices. Files exist to store information on storage devices (e.g., magnetic disks) and allow the information to be retrieved later. A file system is a collection of files and directories plus operations on them. To keep track of files, file systems have directories. A directory entry provides the information needed to find the blocks associated with a given file.

A snapshot of a file system will capture the content (i.e., files and directories) at an instant in time. A snapshot generally includes the active data that an application can read and write at the time the snapshot is created. These snapshots can be taken periodically, hourly, daily, or weekly or on user demand. They are useful for a variety of applications including recovery of earlier versions of a file following an unintended deletion or modification, backup, data mining, or testing of software.

Accordingly, prior technologies typically capture numerous snapshots of the file systems for the variety of applications. Additionally, with these prior technologies, multiple copies of a single snapshot of the file system are often stored in different storage containers. Accordingly, these prior technologies require multiple storage containers storing large amounts of redundant as data in multiple storage containers. As a result, these prior technologies are not utilizing storage in these storage containers efficiently.

### SUMMARY

A method for providing a unified storage for backup and disaster recovery includes capturing by a storage management computing device a recent snapshot of one or more file systems associated with a client computing device. The captured recent snapshot is stored in a secondary storage device by the storage management computing device. One or more changes to one or more files in the one or more file systems are determined by comparing the stored recent snapshot against an initial snapshot by the storage management computing device. A response to a disaster recovery request or a backup request based on the determined one or more changes to the one or more file systems is provided by the storage management computing device.

A non-transitory computer readable medium having stored thereon instructions for providing a unified storage for backup and disaster recovery comprising executable code which when executed by a processor, causes the processor to perform steps including capturing a recent snapshot of one or more file systems associated with a client computing device. The captured recent snapshot is stored in a secondary storage device. One or more changes to one or more files in the one or more file systems are determined by comparing the stored recent snapshot against an initial snapshot. A response to a disaster recovery request or a backup request based on the determined one or more changes to the one or more file systems is provided.

A storage management computing device includes a processor and a memory coupled to the processor which is configured to be capable of executing programmed instructions comprising and stored in the memory to capture a recent snapshot of one or more file systems associated with a client computing device. The captured recent snapshot is stored in a secondary storage device. One or more changes to one or more files in the one or more file systems are determined by comparing the stored recent snapshot against an initial snapshot. A response to a disaster recovery request or a backup request based on the determined one or more changes to the one or more file systems is provided.

This technology provides a number of advantages including providing methods, non-transitory computer readable medium and devices for providing unified storage for disaster recovery and data backup. By storing multiple snapshots of the file system within a single storage container, the technology is able to prevent the requirement of multiple storage containers thereby significantly reducing the storage space required to assist with disaster recovery and data backup. Additionally, the technology disclosed herein uses file level transfer of data that further reduces the amount of data stored in the storage container. These techniques collectively improve the storage efficiency and the performance of the storage management computing device.

### BRIEF DESCRIPTION OF THE DRAWINGS

FIG. 1 is a block diagram of an environment with an exemplary storage management computing device;

FIG. 2 is a block diagram of the exemplary storage management computing device shown in FIG. 1; and

FIG. 3 is a flow chart of an example of a method for providing unified storage for backup and disaster recovery.

### DETAILED DESCRIPTION

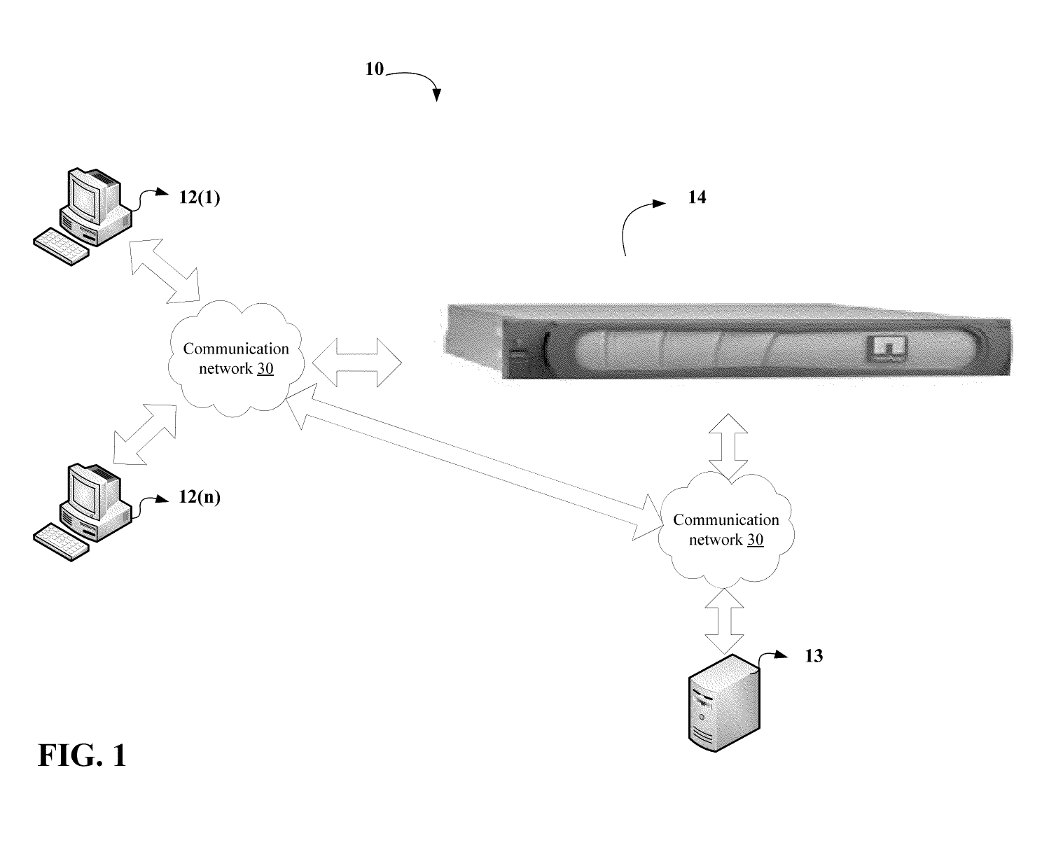

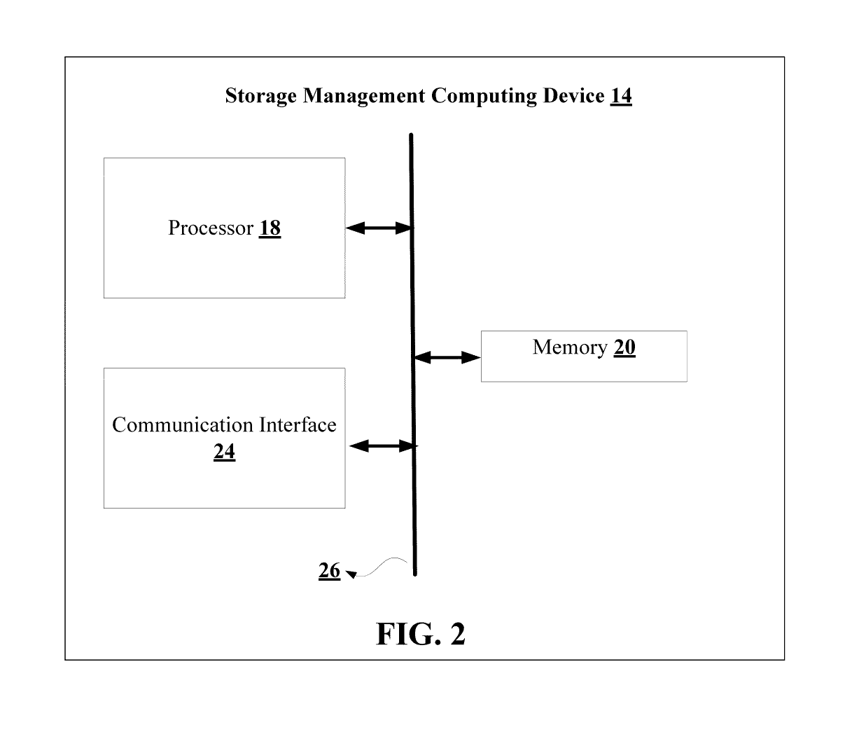

An environment 10 with a plurality of client computing devices 12(1)-12(n), a secondary storage device 13 and an exemplary storage management computing device 14 is illustrated in FIGS. 1-2. In this particular example, the environment 10 includes the plurality of client computing devices 12(1)-12(n), the secondary storage device 13, and the storage management computing device 14 coupled via one or more communication networks 30, although the environment could include other types and numbers of systems, devices, components, and/or other elements. In this example, the method for providing unified storage for backup and disaster recovery is executed by the storage management computing device 14 although the approaches illustrated and described herein could be executed by other systems and devices. The environment 10 may include other types and numbers of other network elements and devices, as is generally known in the art and will not be illustrated or described herein. This technology provides a number of advantages including providing methods, non-transitory computer readable medium and devices for providing unified storage for backup and disaster recovery.

Referring more specifically to FIG. 2, in this example the storage management computing device 14 includes a processor 18, a memory 20, and a communication interface 24 which are coupled together by a bus 26, although the storage management computing device 14 may include other types and numbers of elements in other configurations.

The processor 18 of the storage management computing device 14 may execute one or more programmed instructions stored in the memory 20 for replicating data and providing instantaneous access to data as illustrated and described in the examples herein, although other types and numbers of functions and/or other operation can be performed. The processor 18 of the storage management computing device 14 may include one or more central processing units (“CPUs”) or general purpose processors with one or more processing cores, such as AMD® processor(s), although other types of processor(s) could be used (e.g., Intel®).

The memory 20 of the storage management computing device 14 stores the programmed instructions and other data for one or more aspects of the present technology as described and illustrated herein, although some or all of the programmed instructions could be stored and executed elsewhere. A variety of different types of memory storage devices, such as a random access memory (RAM) or a read only memory (ROM) in the system or a floppy disk, hard disk, CD ROM, DVD ROM, or other computer readable medium which is read from and written to by a magnetic, optical, or other reading and writing system that is coupled to the processor 18, can be used for the memory 20.

The communication interface 24 of the storage management computing device 14 operatively couples and communicates with the plurality of client computing devices 12(1)-12(n) and the secondary storage device 13, which are all coupled together by the communication network 30, although other types and numbers of communication networks or systems with other types and numbers of connections and configurations to other devices and elements. By way of example only, the communication network 30 can use TCP/IP over Ethernet and industry-standard protocols, including NFS, CIFS, SOAP, XML, LDAP, and SNMP, although other types and numbers of communication networks, can be used. The communication networks 30 in this example may employ any suitable interface mechanisms and network communication technologies, including, for example, any local area network, any wide area network (e.g., Internet), teletraffic in any suitable form (e.g., voice, modem, and the like), Public Switched Telephone Network (PSTNs), Ethernet-based Packet Data Networks (PDNs), and any combinations thereof and the like. In this example, the bus 26 is a universal serial bus, although other bus types and links may be used, such as PCI-Express or hyper-transport bus.

Each of the plurality of client computing devices 12(1)-12(n) includes a central processing unit (CPU) or processor, a memory, an interface device, and an I/O system, which are coupled together by a bus or other link, although other numbers and types of network devices could be used. The plurality of client computing devices 12(1)-12(n) communicates with the storage management computing device 14 for requesting access to data or files in the secondary storage device 13, although the client computing devices 12(1)-12(n) can interact with the storage management computing device 14 for other purposes. By way of example, the plurality of client computing devices 12(1)-12(n) may run interface application(s) that may provide an interface to make requests to access, modify, delete, edit, read or write data within storage management computing device 14 or the secondary storage device 13 via the communication network 30.

The secondary storage device 13 includes a central processing unit (CPU) or processor, a memory, an interface device, and an I/O system, which are coupled together by a bus or other link, although other numbers and types of network devices could be used. The storage management computing device 14 communicates with the secondary storage device 13 to store and/or obtain file systems associated with the plurality of client computing devices 12(1)-12(n) via communication networks 30, although the storage management computing device 14 can communicate with the secondary storage device 13 for other types of operations.

Although the exemplary network environment 10 includes the plurality of client computing devices 12(1)-12(n), the secondary storage device 13 and the storage management computing device 14 described and illustrated herein, other types and numbers of systems, devices, components, and/or other elements in other topologies can be used. It is to be understood that the systems of the examples described herein are for exemplary purposes, as many variations of the specific hardware and software used to implement the examples are possible, as will be appreciated by those of ordinary skill in the art.

In addition, two or more computing systems or devices can be substituted for any one of the systems or devices in any example. Accordingly, principles and advantages of distributed processing, such as redundancy and replication also can be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic media, wireless traffic networks, cellular traffic networks, G3 traffic networks, Public Switched Telephone Network (PSTNs), Packet Data Networks (PDNs), the Internet, intranets, and combinations thereof.

The examples also may be embodied as a non-transitory computer readable medium having instructions stored thereon for one or more aspects of the present technology as described and illustrated by way of the examples herein, as described herein, which when executed by the processor, cause the processor to carry out the steps necessary to implement the methods of this technology as described and illustrated with the examples herein.

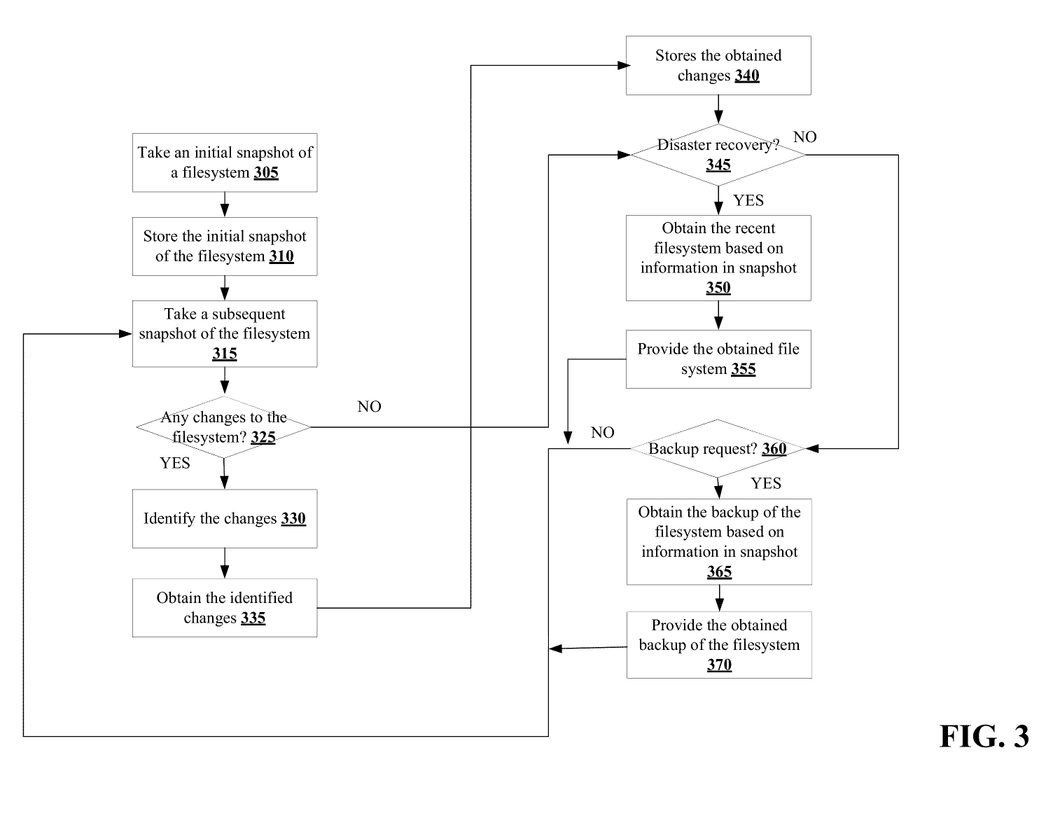

An exemplary method for providing unified storage for backup and disaster recovery will now be described herein with reference to FIGS. 1-3.

In step 305, the storage management computing device 14 takes an initial (old) snapshot of file systems on each of the plurality of client computing devices 12(1)-12(n). In this example, each snapshot relates to information associated with the state of the file systems at a particular point of time. For purpose of further illustration, the storage management computing device 14 periodically takes a snapshot of the file systems within each of the plurality of client computing devices 12(1)-12(n) at periodic instant of time.

In step 310, the storage management computing device 14 stores the initial snapshot of each of the file systems of the plurality of client computing devices 12(1)-12(n) in the secondary storage device 13, although the storage management computing device 14 can store the snapshots at other memory locations including memory 20. Additionally, the secondary storage device 13 includes all the information associated with the files present in each of the file systems associated with all of the plurality of client computing devices 12(1)-12(n).

Next in step 315, the storage management computing device 14 captures a subsequent (or a recent) snapshot of the file systems within each of the plurality of client computing devices 12(1)-12(n) after a pre-defined time period. By way of example only, a pre-defined time period can be every two minutes, although the pre-defined time period can be other time ranges.

In step 325, the storage management computing device 14 determines if there are any changes to any file systems in any of the plurality of client computing devices 12(1)-12(n) by comparing the initial and subsequent snapshots of each file systems of the plurality of client computing devices 12(1)-12(n). In this example, the information present in each subsequent snapshot may be different to than the initial snapshot indicating any changes to the file systems. Accordingly, when the storage management computing device 14 determines there are no changes to the file system, then the No branch is taken to step 345 which will be further illustrated and described below. However, when the storage management computing device 14 determines there are changes to at least one file system in at least one of the plurality of client computing devices 12(1)-12(n), then the Yes branch is taken to step 330.

In step 330, the storage management computing device 14 identifies changes to one or more files within the file system that is determined to have changed in at least one of the plurality of client computing devices 12(1)-12(n). In this example, the storage management computing device 14 identifies the changes based on the comparison technique illustrated in step 325, although the storage management computing device 14 can use other techniques to identify any changes to any files within the file system.

In step 335, the storage management computing device 14 obtains the identified changes from the one of the plurality of client computing devices 12(1)-12(n) associated with the changed file system. In this example, the storage management computing device 14 obtains only the changes to the one or more files and not the entire or underlying file systems from the one of the plurality of client computing devices 12(1)-12(n). This technique of obtaining only changes associated with the one or more files with changes is defined as file level data transfer, in this example. Alternatively, in another example, the storage management computing device 14 obtains the entire file with the identified changes without the entire or underlying file system from one of the plurality of client computing devices 12(1)-12(n) associated with the changed file system. By obtaining changes only associated with the file and not the entire file system, the technology provides advantages of effectively reducing the storage space for back of the file system

In step 340, the storage management computing device 14 stores the obtained changes in the secondary storage device 13, although the storage management computing device 14 can store at other memory locations including memory 20. In this example, the storage management computing device 14 creates a new version of the file with the obtained changes and saves the new version of the file in the memory 20. Additionally, the storage management computing device 14 also stores the previous version of the file without the obtained changes separately in the secondary storage device 13.

Next in step 345, the storage management computing device 14 determines if there is a disaster recovery request from at least one of the plurality of client computing devices 12(1)-12(n). By way of example only, the plurality of client computing devices 12(1)-12(n) may undergo an event such as frozen application, unscheduled termination of power, or corrupt memory in client computing device that results in the loss of data. When the plurality of client computing devices 12(1)-12(n) encounters the previously listed events, the affected one of the plurality of client computing devices 12(1)-12(n) sends out a disaster recovery request to the storage management computing device 14. In this example, the disaster recovery request includes a request for the most recent version of the files, although the disaster recovery request can include other types or amounts of information. Accordingly, when the storage management computing device 14 determines that it has not received the disaster recovery request, then the No branch is taken to step 360 which will be further illustrated below. However, if the storage management computing device 14 determines that it has received the disaster recovery request, then the Yes branch is taken to step 350.

In step 350, the storage management computing device 14 obtains the most recent version of the file system associated with the affected one of the plurality of client computing devices 12(1)-12(n) using the information stored in the subsequent snapshots from the secondary storage device 13, although the storage management computing device 14 can obtain the file system from other memory location including memory 20 using other parameters. In this example, the most recent version of the file system associated with the affected one of the plurality of client computing devices 12(1)-12(n) includes the identified, obtained and stored changes to the file systems illustrated in the previous steps, although the most recent version can include types or amounts of information. Alternatively, in another example, the storage management computing device can obtain the file system associated with the affected one of the plurality of client computing devices 12(1)-12(n) using both the initial snapshot and the subsequent snapshot.

In step 355, the storage management computing device 14 provides the affected one of the plurality of client computing devices 12(1)-12(n) with the obtained most recent version of the file system responsive to the received request and the exemplary flow proceeds back to step 315.

Back in step 345, when the storage management computing device 14 determines that it has not received a disaster recovery request, then the No branch is taken to step 360. In step 360, the storage management computing device 14 determines if there is a file system backup request from at least one of the plurality of client computing devices 12(1)-12(n). By way of example only, the plurality of client computing devices 12(1)-12(n) may send out a backup request to the storage management computing device 14 when the data associated with the file system to be backed-up onto a new client computing device, although the plurality of client computing devices 12(1)-12(n) can send out backup requests during other circumstances. In this example, the backup request includes a request for the all versions of the files (both old version and new version) in the file systems associated with the affected one of the plurality of client computing devices 12(1)-12(n). Accordingly, when the storage management computing device 14 determines that it has not received the backup request from the plurality of client computing devices 12(1)-12(n), then the No branch is taken back to step 315 where the storage management computing device 14 continues to take the next snapshot of the file systems in the plurality of client computing devices 12(1)-12(n). However, when the storage management computing device 14 determines that it has received the backup request, then the Yes branch is taken to step 365.

In step 365, the storage management computing device 14 obtains the backup of the file systems associated with the affected one of the plurality of client computing devices 12(1)-12(n) using the information in both initial and subsequent snapshots of the affected one of the plurality of client computing devices 12(1)-12(n). In this example, the storage management computing device 14 is able to obtain the backup of the file system from the secondary storage device 13 or can re-create the file system using the information in both the initial and subsequent snapshots. Additionally in this example, the obtained backup of the file systems associated with the affected one of the plurality of client computing devices 12(1)-12(n) includes the one or more file systems with the identified, obtained and stored changes previously illustrated and the one or more file systems without the changes. Alternatively in another example, the storage management computing device 14 can obtain or re-create the file system using information present in either the initial or subsequent snapshot.

In step 370, the storage management computing device 14 provides the obtained snapshot back to the requesting (affected) one of the plurality of client computing devices 12(1)-12(n) and the exemplary method flows back to step 315 where the storage management computing device 14 continues to take the next snapshot of the file systems in the plurality of client computing devices 12(1)-12(n).

Accordingly, as illustrated and described with reference to the examples herein, this technology provides methods, non-transitory computer readable medium and devices that are able to efficiently provide unified storage for disaster recovery and data backup. By storing multiple snapshots of the file system within a single storage container, the technology is able to prevent the requirement of multiple storage containers thereby significantly reducing the storage space required to assist with disaster recovery and data backup. Additionally, the technology disclosed herein uses file level transfer of data that further reduces the amount of data stored in the storage container. These techniques collectively improve the storage efficiency and the performance of the storage management computing device.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for providing a unified storage for backup and disaster recovery, the method comprising:
capturing, by a storage management computing device, a recent snapshot of one or more file systems associated with a client computing device;
storing, by the storage management computing device, the captured recent snapshot in a secondary storage device;
determining, by the storage management computing device, one or more changes to one or more files in the one or more file systems by comparing the stored recent snapshot against an initial snapshot; and
providing, by the storage management computing device, a response to a disaster recovery request or a backup request based on the determined one or more changes to the one or more file systems.

2. The method as set forth in claim 1 further comprising:
capturing, by the storage management computing device, the initial snapshot of the one or more file systems associated with the client computing device; and
storing, by the storage management computing device, the captured initial snapshot.

3. The method as set forth in claim 1 wherein, the determining the one or more changes further comprises:
obtaining, by the storage management computing device, only the determined one or more changes to the one or more files without the one or more file systems; and
storing, by the storage management computing device, the obtained one or more changes to the one or more files in the secondary storage device.

4. The method as set forth in claim 3 further comprising:
receiving, by the storage management computing device, the disaster recovery request from the client computing device;
obtaining, by the storage management computing device, one or more stored file systems associated with the client computing device based on information in the stored subsequent snapshot from the secondary storage device, the one or more stored file systems comprising only the obtained one or more changes to the one or more files; and
providing, by the storage management computing device, the obtained one or more stored file systems to the requesting client computing device.

5. The method as set forth in claim 3 further comprising:
receiving, by the storage management computing device, the backup request from the client computing device;
obtaining, by the storage management computing device, one or more stored backup file systems associated with the client computing device based on information in the stored initial snapshot and the stored subsequent snapshot from the secondary storage device, the one or more stored backup file systems comprising the obtained one or more changes to the one or more files and the one or more files without the obtained one or more changes; and
providing, by the storage management computing device, the obtained one or more stored backup file systems to the requesting client computing device.

6. A non-transitory computer readable medium having stored thereon instructions for providing a unified storage for backup and disaster recovery comprising executable code which when executed by a processor, causes the processor to perform steps comprising:
capturing a recent snapshot of one or more file systems associated with a client computing device;
storing the captured recent snapshot in a secondary storage device;
determining one or more changes to one or more files in the one or more file systems by comparing the stored recent snapshot against an initial snapshot; and
providing a response to a disaster recovery request or a backup request based on the determined one or more changes to the one or more file systems.

7. The medium as set forth in claim 6 further comprising:
capturing the initial snapshot of the one or more file systems associated with the client computing device; and
storing the captured initial snapshot.

8. The medium as set forth in claim 6 wherein, the determining the one or more changes further comprises:
obtaining only the determined one or more changes to the one or more files without the one or more file systems; and
storing the obtained one or more changes to the one or more files in the secondary storage device.

9. The medium as set forth in claim 8 further comprising:
receiving the disaster recovery request from the client computing device;
obtaining one or more stored file systems associated with the client computing device based on information in the stored subsequent snapshot from the secondary storage device, the one or more stored file systems comprising only the obtained one or more changes to the one or more files; and
providing the obtained one or more stored file systems to the requesting client computing device.

10. The medium as set forth in claim 8 further comprising:
receiving the backup request from the client computing device;
obtaining one or more stored backup file systems associated with the client computing device based on information in the stored initial snapshot and the stored subsequent snapshot from the secondary storage device, the one or more stored backup file systems comprising the obtained one or more changes to the one or more files and the one or more files without the obtained one or more changes; and
providing the obtained one or more stored backup file systems to the requesting client computing device.

11. A storage management computing device comprising:
a processor;
a memory coupled to the processor which is configured to be capable of executing programmed instructions comprising and stored in the memory to:
capture a recent snapshot of one or more file systems associated with a client computing device;
store the captured recent snapshot in a secondary storage device;
determine one or more changes to one or more files in the one or more file systems by comparing the stored recent snapshot against an initial snapshot; and
provide a response to a disaster recovery request or a backup request based on the determined one or more changes to the one or more file systems.

12. The device as set forth in claim 11, wherein the processor coupled to the memory is further configured to be capable of executing at least one additional programmed instruction comprising and stored in the memory to:
capture the initial snapshot of the one or more file systems associated with the client computing device; and
store the captured initial snapshot.

13. The device as set forth in claim 11, wherein the processor coupled to the memory is further configured to be capable of executing the programmed instructions further comprising and stored in the memory to determine the one or more changes further comprises:
obtain only the determined one or more changes to the one or more files without the one or more file systems; and
store the obtained one or more changes to the one or more files in the secondary storage device.

14. The device as set forth in claim 13, wherein the processor coupled to the memory is further configured to be capable of executing at least one additional programmed instruction comprising and stored in the memory to:
receive the disaster recovery request from the client computing device;
obtain one or more stored file systems associated with the client computing device based on information in the stored subsequent snapshot from the secondary storage device, the one or more stored file systems comprising only the obtained one or more changes to the one or more files; and
provide the obtained one or more stored file systems to the requesting client computing device.

15. The device as set forth in claim 13, wherein the processor coupled to the memory is further configured to be capable of executing at least one additional programmed instruction comprising and stored in the memory to:
receive the backup request from the client computing device;
obtain one or more stored backup file systems associated with the client computing device based on information in the stored initial snapshot and the stored subsequent snapshot from the secondary storage device, the one or more stored backup file systems comprising the obtained one or more changes to the one or more files and the one or more files without the obtained one or more changes; and
provide the obtained one or more stored backup file systems to the requesting client computing device.
